(19) United States
(12) Patent Application Publication
(10) Pub. No.: US 2018/0076541 A1
(43) Pub. Date: Mar. 15, 2018

(54) CONNECTING SYSTEM USING LATERAL PRESS-FIT PINS

(71) Applicant: Continental Automotive Systems, Inc., Auburn Hills, MI (US)

(72) Inventors: Jennifer Matoy, Leonard, MI (US); Federico Austriaco, Lake Orion, MI (US)

(21) Appl. No.: 15/264,260

(22) Filed: Sep. 13, 2016

(51) Int. Cl. H01R 12/58; H01R 43/20

(52) U.S. Cl. CPC H01R 12/585; H01R 43/20

(57) ABSTRACT

L-shaped connector pins are press-fit into through-holes located near the edge of a circuit board. One leg of a pin extends into the through-hole; the other leg extends horizontally over the circuit board and past the circuit board's edge where it can be attached to a mating receptacle connector. The height of the L-shaped connector pins can be reduced to be less than the height of electronic devices on the circuit board. The number of pins for any circuit board can be customized, reducing connector cost.

### BACKGROUND

As the complexity of electronic systems increases, connecting various different circuit boards that often make up such systems can become problematic, and expensive. Prior art connector pin headers used for connecting circuit boards together use an over-molded plastic carrier, which is costly, bulky and typically has more pins in it than are might be needed for an actual device. A connecting system that provides for a simpler, less-expensive and customizable number of pins for a circuit board connector would be an improvement over the prior art.

### BRIEF DESCRIPTION OF THE FIGURES

FIG. 1 is a perspective view of an electrical connecting system comprising a planar circuit board, several cylindrical holes in the circuit board, and two substantially L-shaped connector pins having orthogonal legs;

FIG. 2 is a side view of the electrical connecting system shown in FIG. 1;

FIG. 3 is a perspective view of an alternate embodiment of an electrical connecting system comprised of a planar circuit board having a cylindrical hole, and a substantially, L-shaped pin with a rhombus-shaped leg configured to be press-fit into the cylindrical hole;

FIG. 4 is a perspective view of a planar circuit board and several, substantially L-shaped pins press-fit into holes of a planar circuit board;

FIG. 5 is a perspective view of a planar circuit board, with an upper or top row of substantially L-shaped pins on a top surface of the circuit board and a second, lower bottom row of substantially L-shaped pins press-fit into the lower side of the circuit board;

FIG. 6 is a perspective view of a planar circuit board having a top row of substantially L-shaped pins press-fit into a top surface of a circuit board, the pins being spaced unevenly, and, a second set of pins press-fit into the bottom or second side of the circuit board, also spaced unevenly;

FIG. 7 is a side or cross-sectional view of an electrical connecting system comprising three layers of lateral, press-fit pins, which are substantially L-shaped;

FIG. 8 is a perspective view of the assembly shown in FIG. 7;

FIG. 9 is a perspective view of a connecting system embodiment having top and bottom rows of lateral press-fit pins attached to the top and bottom surfaces of a circuit board respectively and showing their alignment to lines parallel to an edge of the circuit board;

FIG. 10 is a perspective view of a connecting system having a spacer or retainer block to maintain pitch distance of the pins;

FIG. 11 is a perspective view of a fixture, configured to hold L-shaped pins to they can be press-fit into circuit board holes;

FIG. 12 is an exploded, perspective view of the fixture shown in FIG. 11 and with a printed circuit board located to be press-fit onto the substantially L-shaped pins of the connector pins shown in FIG. 11;

FIG. 13 is a perspective view of a final position of a printed circuit board on top of the fixture depicted in FIG. 11;

FIG. 14 is a flow chart showing steps of a method or assembling an electrical connecting system using lateral press-fit pins; and

FIG. 15 shows the cross-section of a circuit board connector pin hole and cross-sectional views of various types of connector pins which when sized appropriately with the connector pin hole can provide an interference fit.

### DETAILED DESCRIPTION

The terms, “press-fit” and “interference fit” are used interchangeably. They refer to a fit between two parts in which the external dimension of one part slightly exceeds the internal dimension of the other part into which it has to fit. As is well known, assembling parts having an interference fit or press-fit requires the application of some force to join the parts together. Parts having a “clearance fit” or “transition fit” between them do not require force to assemble them.

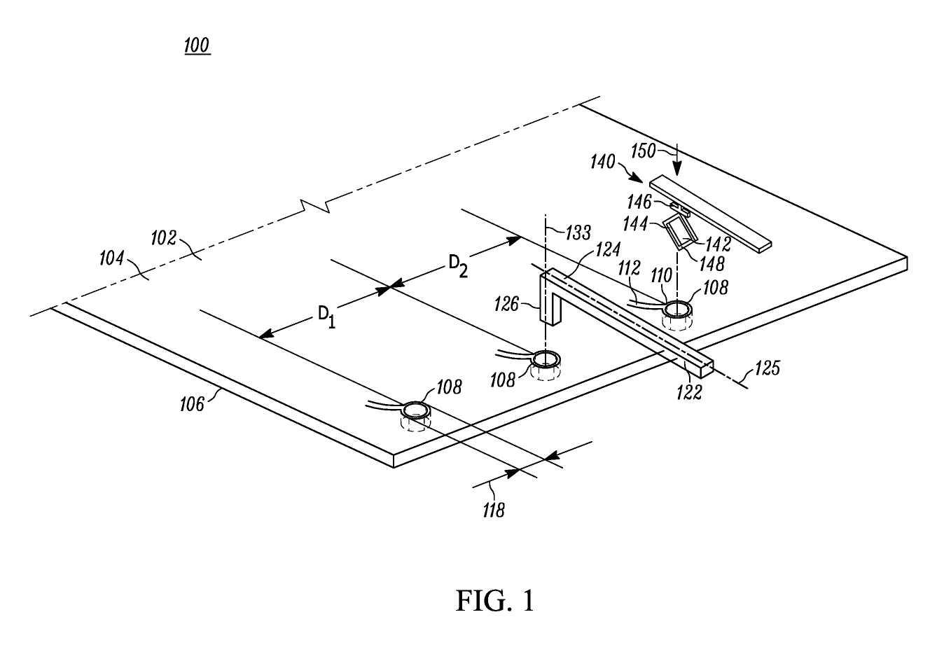

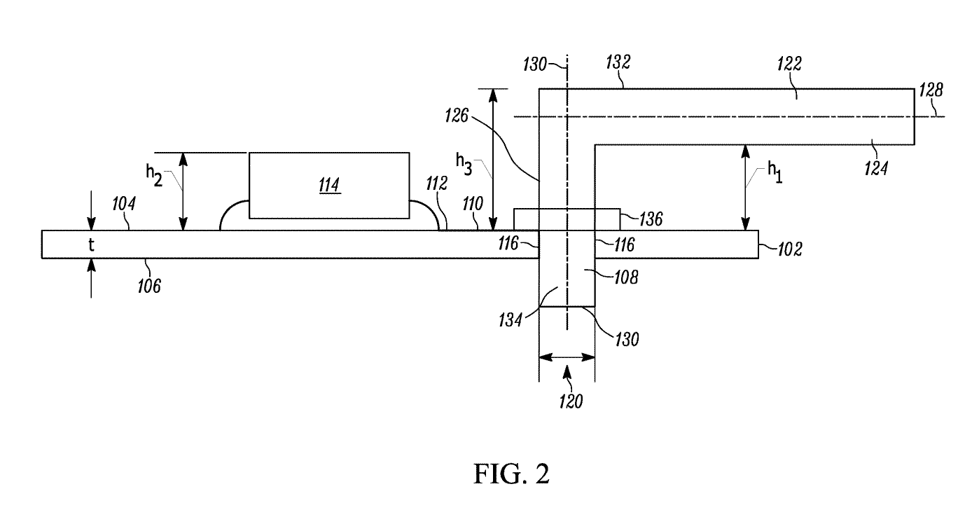

FIG. 1 is a perspective view of an electrical connecting system 100. FIG. 2 is a side view of the system shown in FIG. 1. As shown in FIGS. 1 and 2, the electrical system 100 depicted therein is made up of a substantially planar circuit board 102 having a substantially planar top surface 104 and a substantially planar and parallel bottom surface 106. Several through-holes 108 extend completely through the circuit board 102, i.e., through both the top surface 104 and the bottom surface 106.

The through holes 108 are considered to have a top end, which is located at the top surface or side 104. The through-holes 108 are surrounded by annular-shaped conductors 110 from which extend conductive circuit traces 112. As best seen in FIG. 2, conductive traces 112 lead to, and electrically connect, components 114 on the circuit board 102 to the annular-shaped conductors 110.

In addition to being surrounded by conductive material on circuit board surfaces, each through-hole 108 is also “lined” or plated with a thin layer of conductive material 116. The thickness of the conductive material 116 lining the through-holes 108 provides the through-holes 108 with an inside diameter 118 selected to be slightly smaller than the greatest outside dimension 120 of an L-shaped pin 122. The inside diameter 118 of the through-holes and the outside shapes and dimensions of the L-shaped connector pins are selected or chosen such that when a pin requires the application of a compressive force in order for the pin to be inserted into a through hole.

As can be seen best in FIG. 2, the embodiment of an L-shaped pin 122 depicted therein is considered to have two legs 124 and 126, which are substantially orthogonal to each other. Each of the legs 124, 126 has a corresponding central axis 128 and 130. The first leg, 126 which is considered herein to be vertical, has a cross-sectional size and shape, which as mentioned above, is selected or chosen such that inserting the first leg 126 into a through hole 108 requires a downwardly-directed mechanical force applied to the first leg 126. The through-hole inside diameter 118 is of course also selected to provide an interference fit to the first leg 126 of the L-shaped pin 122. Stated another way, the cross-sectional shape and cross-sectional area of the through-hole 108 is selected with the cross-sectional shape and cross-sectional area of the first leg 126 of the connector pin 122 in order to provide an interference fit between the hole 108 and the leg 126.

Still referring to FIG. 2, the circuit board 102 has a nominal thickness, denominated as “t.” The first leg 126 of the pin 122 has a length greater than t and considered herein to be the distance between a bottom or distal end 131. The first leg 126 has a top end 132 located above the top surface 104 of the circuit board 102. The bottom end 131 is located below the bottom surface 106 of the circuit board 102 and below the second leg 124, which extends horizontally away from the first leg 126 and is substantially parallel to the top surface 104 of the circuit board 102. A portion 134 of the first leg 26 is below the bottom 106 of the circuit board 102.

Above the top surface 104 of the circuit board 102 there can be seen a substantially rectilinear-shaped shoulder 136. The shoulder 136 “rests” on top of the conductive annulus 110 and is both electrically and mechanically in contact with the conductive annular 110. The shoulder 136 is sized, shaped and arranged to prevent the first leg 126 of the substantially L-shaped pin 122 from being further inserted through the hole 108. Stated another way, the shoulder 136 has a cross-sectional shape and a cross-sectional area which is greater than the through-hole 108. The shoulder 136 holds or keeps the second leg of the L-shaped pin above the top surface of the circuit board.

Those of ordinary skill in the art should recognize that the interference or press-fit between the first leg 126 and the conductive material 116 lining the hole 108 and, the electrical connection between the shoulder 136 and the conductive annulus 110 provide an electrical connection between the L-shaped pin 122 and other electronic devices 114 on the circuit board 102 via conductive circuit traces 112 extending between such electronic devices and the pin 122.

A rhomboid is well known as a parallelogram with no right angles and with adjacent sides of unequal length. A hexagon is a polygon with six angles and six sides.

Referring now to FIG. 1, an alternate embodiment of an L-shaped lateral press-fit pin is identified by reference numeral 140. Unlike the pin identified by reference numeral 122, the pin identified by reference numeral 140 has a lower or first leg 142 made up of a substantially rhomboid-shaped spring 144. The spring 144 is considered to be substantially rhomboid shaped because it resembles a parallelogram with no right angles and adjacent sides that have unequal lengths. Alternative and equivalent embodiments include a spring which is substantially hexagonal, i.e., having six sides and six angles. Regardless of whether the spring 144 is rhomboid-shaped or hexagonal, a substantially rectangular-shaped shoulder 146 is located above the spring 144 to keep the spring 144 above the circuit board's surface.

The bottom end 148 of the rhomboid-shaped spring 144 is essentially a point where two adjacent sides meet. The cross-sectional shape and area of the pointed bottom end 148 fits readily into a through-hole 108. A compressive force 150, applied downwardly, causes the sides of the rhomboid-shaped spring to compress as the spring is urged downwardly into the through-hole 108.

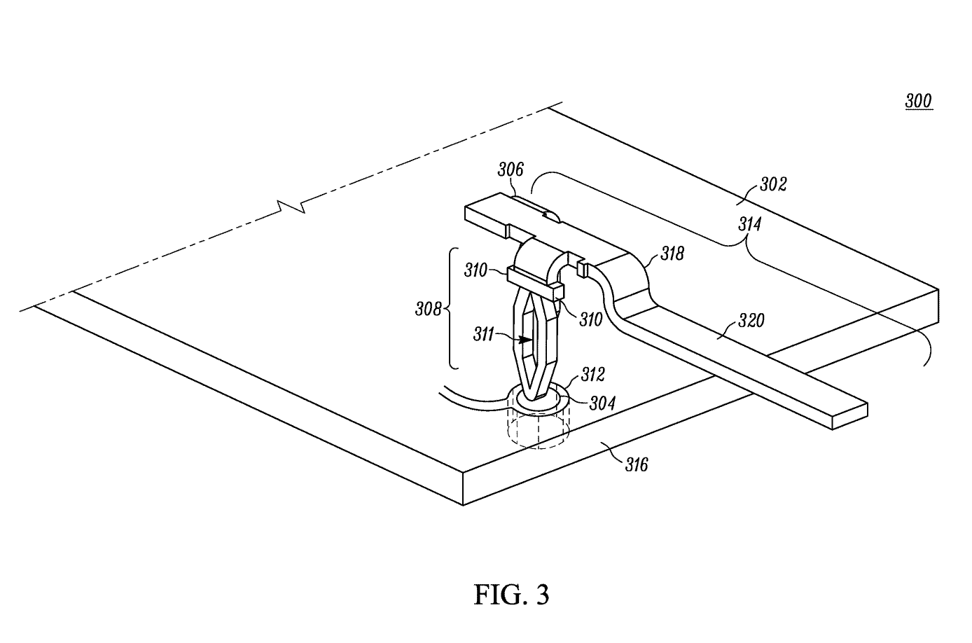

FIG. 3 is a perspective view of an alternate embodiment of an electrical connecting system 300 and showing a preferred embodiment of a substantially L-shaped pin, sized and shaped to be press fit into a connector pin hole of a circuit board. Similar to the electrical connecting system shown in FIG. 1 and FIG. 2, the electrical connecting system 300 shown in FIG. 3 comprises a planar circuit board 302 with a plurality of through-holes 304, however, only one hole 304 is shown in the interest of clarity, above which is the aforementioned substantially L-shaped connector pin 306.

The pin has a first leg 308, oriented to be substantially vertical. It comprises the aforementioned rhomboid-shaped or hexagon-shaped spring 311, sized and shaped to fit into the through-hole 304. When the spring is compressed, it maintains an interference fit between itself and the inside diameter of the through-hole 304, which is also coated with a conductive material.

Similar to the second conductor pin 140 shown in FIG. 1, the connector pin 306 shown in FIG. 3 has a shoulder 310 sized and shaped to stop further insertion of the pin 306 when it makes a physical and electrical contact with a conductive annulus 312 deposited onto the top surface of the circuit board 302 and surrounding the through-hole 304.

The inside diameter of the through-hold 304 and the size and shape of the rhomboid-shaped spring are cooperatively selected such that the spring and through-hole 304 require force to be joined to one another and thus provide an interference fit between them.

The second leg of the pin 306 is identified by reference numeral 314. The second leg 314 is also substantially orthogonal to the first leg 308. The second leg 314 extends laterally and horizontally away from the leg 308 toward a nearby edge 316 of the circuit board 302. The length of the second leg 314 is selected such that the leg 306 extends past or beyond the nearby edge 316.

The second leg 314 is also provided with a bend or curve 318 which essentially and effectively lowers an outward portion 320 of the pin 306.

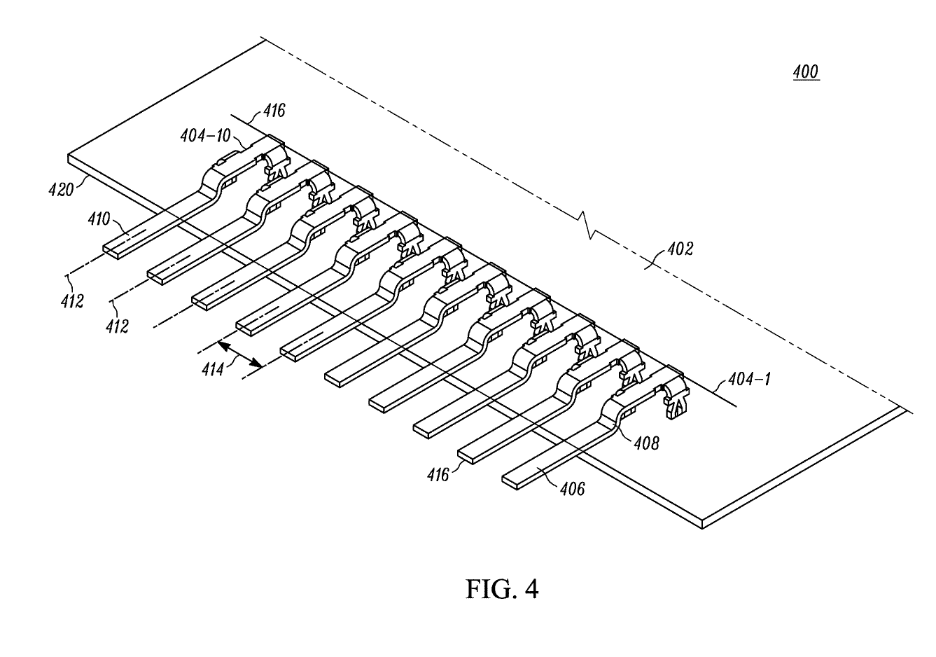

FIG. 4 is a perspective view of an electrical connecting system 400 also comprising a planar circuit board 402 through which are formed several through-holes 404-1 through 404-10. The several pins 406 are the same press-fit pin shown in FIG. 3 and identified in FIG. 3 by reference numeral 306. Each pin 406 of FIG. 4 has a first leg, extending through the circuit board 402 and which comprises the aforementioned rhomboid-shaped spring.

In the embodiment shown, each pin 406 also has a knee or bend 408 which vertically lowers a “distal” portion 410 of the pins' second leg (320 in FIG. 3) downwardly and closer to the top surface of the circuit board 402. The knee or bend 408 is optional and can be omitted.

Still referring to FIG. 4, each of the pins' second leg 406 has an axis 412. The lateral or side-to-side separation distance between the adjacent axes 412 defines a pin-to-pin separation distance, also known as a “pitch” 414. The pin-to-pin pitch 414 shown in FIG. 4 is uniform or even, i.e., each pin is laterally separated from its neighbor by the same distance.

The holes 404 into which the pins 406 are pressed are substantially co-linear, i.e., lying along a geometric line identified in FIG. 4 by reference numeral 418. The distal ends 412 of the second legs of the pins 406 are thus uniformly extant from a nearby edge 420 of the circuit board 402.

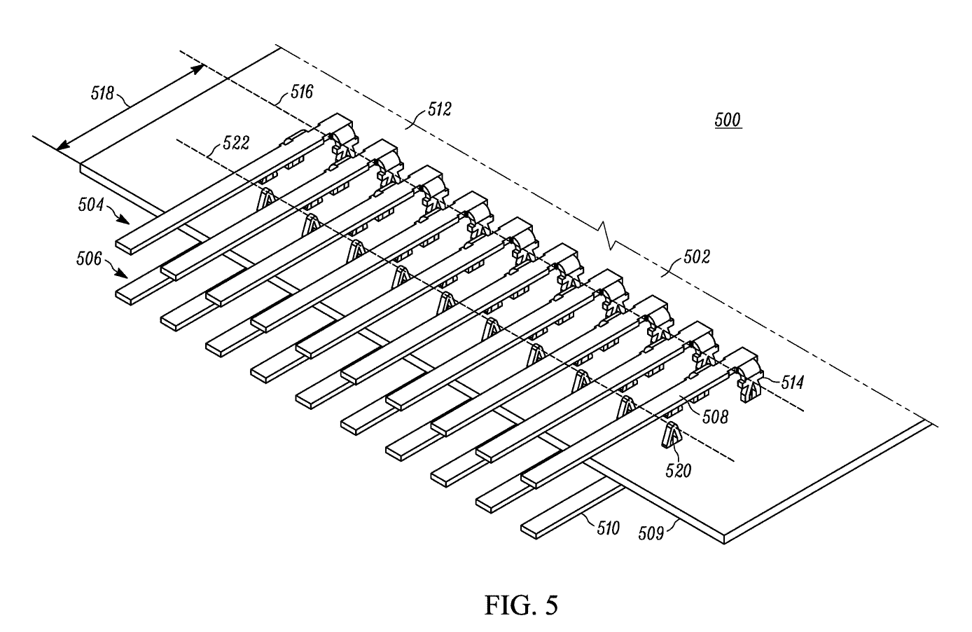

FIG. 5 is a perspective view of yet another embodiment of an electrical connecting system 500. The system 500 shown in FIG. 5 also comprises a substantially planar circuit board 502. Unlike the embodiments described above, the electrical connecting system 500 depicted in FIG. 5 has two rows 504 and 506 of L-shaped lateral press-fit pins 508 and 510. On the top surface 512, of the circuit board 502 a first set of press-fit pins are inserted into a series of through-holes 514 aligned with each other along a geometric line 516 set back from the edge of the circuit board by a distance identified by reference numeral 518.

A second set of pins 510 are attached into through-holes 520 which are aligned with a second geometric line 522 set back from the edge of the circuit board by a lesser distance. The first set of L-shaped pins 508, which are inserted into through-holes 514 from the top side 512 of the circuit board 502 are above the top surface 512 and extend away from each of their corresponding first legs, which are of course inserted into the through-holes 514 with an interference fit. Each of the pins 508 is parallel to each other and substantially parallel to the top side or first side 512 of the circuit board 502. The pins thus provide electrical connectors that extend beyond the edge 509 of the circuit board 502.

The second set of pins 510 have their first legs inserted through through-holes 520 from the bottom or second side of the circuit board 502. They too are parallel to each other, parallel to the second side of the circuit board 502 and extend beyond the edge 509 of the circuit board 502. As with the embodiments described above, the cross-sectional shapes and cross-sectional areas of the holes along with the sizes and shapes of the first legs of the pins are selected and cooperatively sized such that an interference fit exists between the holes and first legs of the pins after those first legs are inserted. The first set of pins 508 and the second set of pins 510 are aligned with corresponding geometric lines that extend through the holes formed into the circuit board 502. The first legs of the pins are preferably embodied as the aforementioned rhomboid-shaped springs. Each first leg also preferably includes a shoulder located between the rhomboid-shaped springs and surfaces of the circuit board into which the pins are inserted.

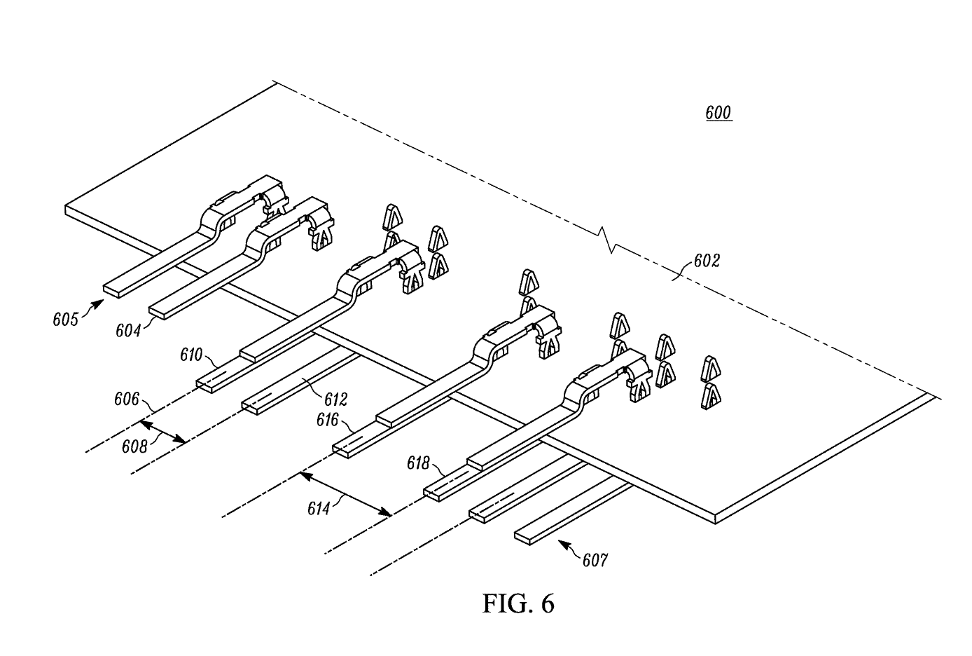

Referring now to FIG. 6, another embodiment of an electrical connecting system 600 comprises a substantially planar circuit board 602 and several unevenly-spaced L-shaped lateral press-fit pins 604 and 606 arranged into two vertically-separated sets 605, 607. Central axes 614 of the second leg portions of each pin are laterally separated unevenly. More particularly, the pin-to-pin separation distance 608 of the first two pins 610 and 612 is less than the separation distance 614 between the third pin 616 and the fourth pin 618. In FIG. 6, both sets of pins are parallel to each other, parallel to surfaces of the circuit board and vertically offset above or away from surfaces of the circuit board into which they were initially inserted.

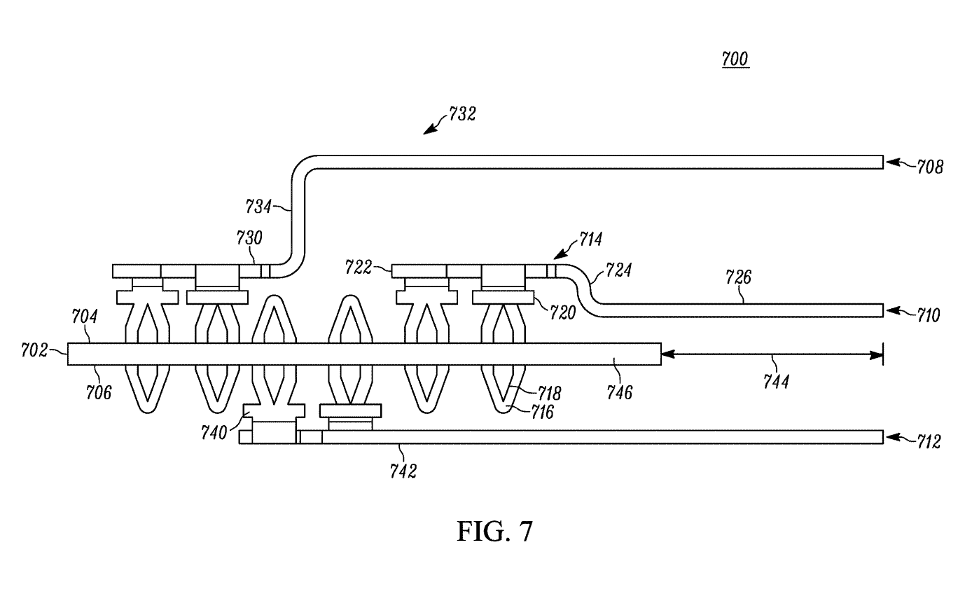

FIG. 7 shows another embodiment of an electrical connecting system 700, also made up of a substantially planar circuit board 702 having a planar top surface 704 and a planar bottom surface 706. The circuit board surfaces support three sets of press-fit pins 708, 710 and 712, two of which 708 and 710 are inserted into the top surface 704 of the circuit board 702. The third set of pins 712 is inserted into the bottom surface 706.

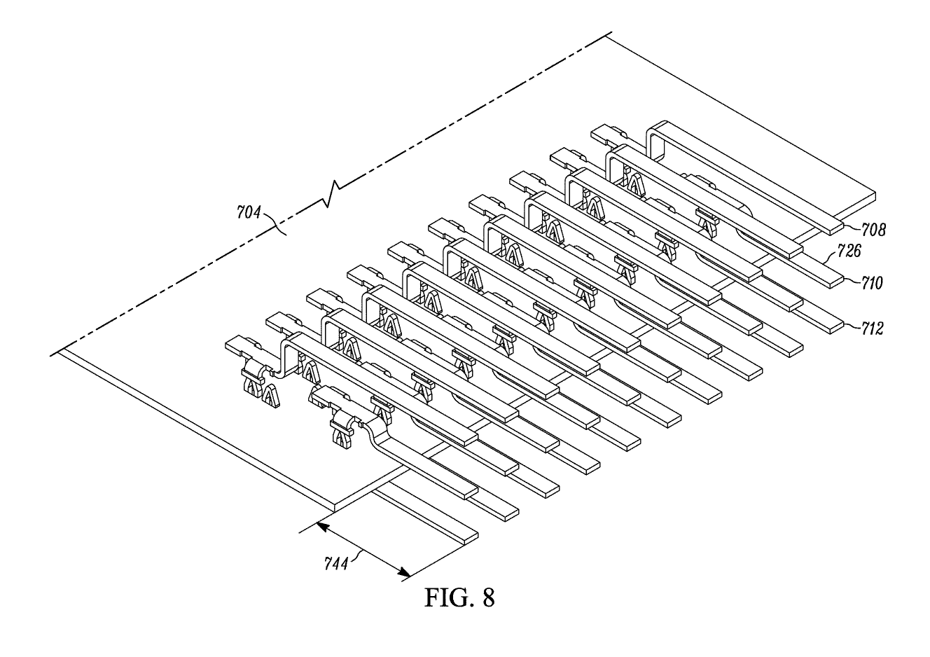

The press-fit connector pin assembly depicted in FIG. 7 in cross-section, can also be seen in a perspective view of FIG. 8. All three sets of pins are substantially uniformly spaced apart from each other horizontally and vertically. The middle set of pins 710 comprises L-shaped press-fit pins 714 the first legs of which 716 have rhomboid-shaped springs and shoulders, 718 and 720 respectively. The second legs 722 are provided with an elbow or bend 724 which lowers the distal or outward segment 726 of the pin 714 closer to the top surface 704 of the circuit board 702.

The top set of pins 708 is also considered herein to be substantially L-shaped but with an upward bend 730 that provides a vertical offset or displacement to the second legs 732. The vertical riser section 734 vertically separates the first set of pins 708 from the second set 710.

The third set of pins 712 is also substantially L-shaped, the first legs of which are also formed with the aforementioned rhomboid-shaped spring and a shoulder. A substantially straight second leg 742 is below the bottom surface 706 of the circuit board 702.

All three sets of pins terminate at the same distance 744 from the circuit board's edge 746.

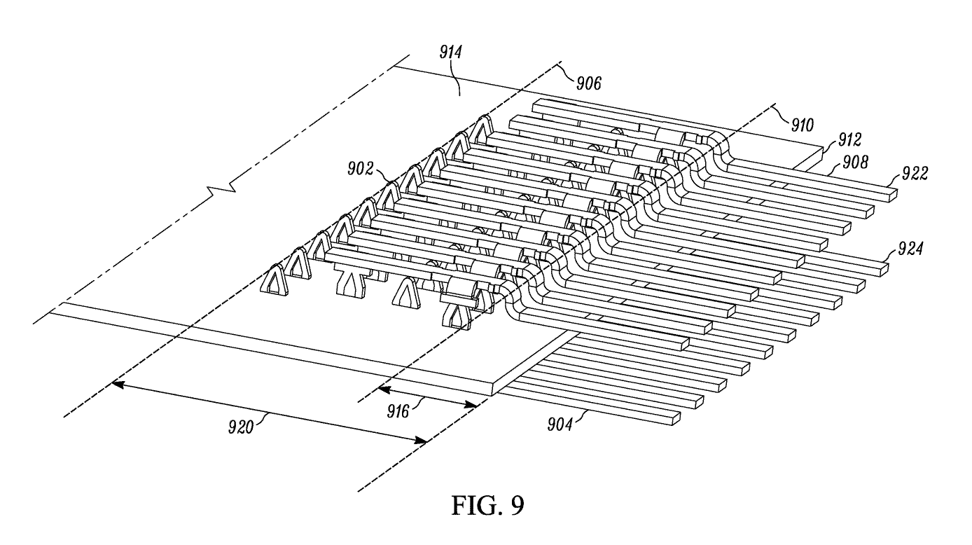

FIG. 9 illustrates the alignment of the first legs 902 of a lower set of L-shaped pins 904 to a geometric alignment line 906. It also illustrates the alignment of first leg sections of a top set of pins 908 to a second and different geometric alignment line 910. The geometric alignment lines 906 and 910 are set back from the nearby edge 912 of the circuit board 914 by different distances 916 and 920, respectively. The ends 922 and 924 of the pins are nevertheless substantially co-planar, i.e. they extend past the edge 912 by the same distance due to the fact that the second legs of each pin are adjusted in part by the bends formed into the second leg pressed into holes from the top of first side of the circuit board.

Those of ordinary skill in the art might recognize that the second legs of the press-fit pins are essentially cantilevered from the first legs, which are press-fit into the circuit board holes. Those of ordinary skill in the art also know that cantilevered beams are subject to sagging. As the length of the second leg increases and their moments of inertia decrease with decreasing cross-sectional areas the second legs of the L-shaped press-fit pins can sag or droop to an extent that can make their insertion into a receptacle, problematic. In some applications, it might be desirable to support the cantilevered pins in order to maintain their spacing vertically as well as horizontally.

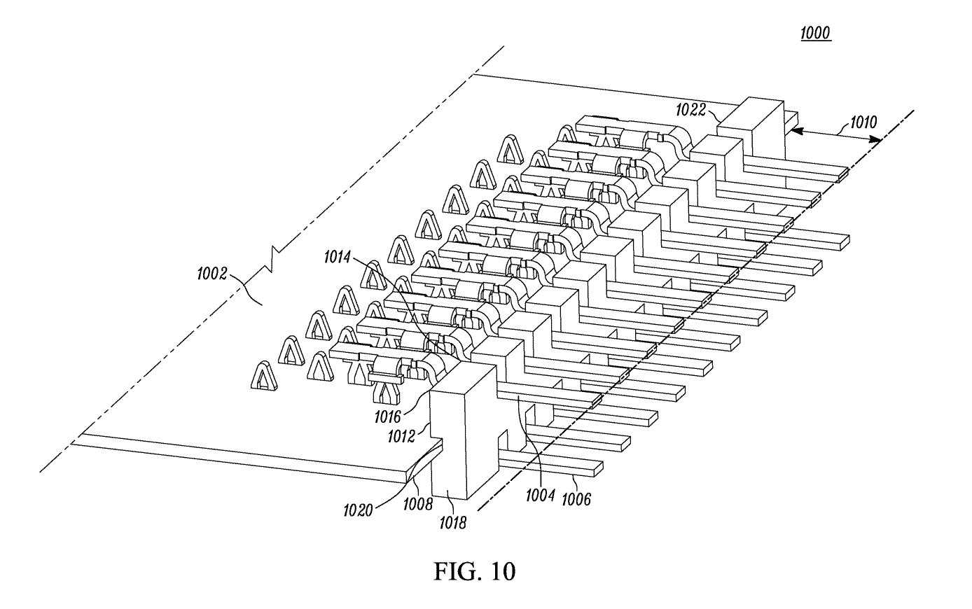

FIG. 10 depicts an electrical connecting system 1000 comprising a substantially planar circuit board 1002 which supports two sets of L-shaped press-fit pins 1004 and 1006. The circuit board 1002 has a front edge 1008. The sets of pins extend past the edge 1008 by the same distance. They are supported vertically and laterally by a plastic spacer 1012 having several slots 1014 formed into a top surface 1016 and a bottom surface 1018. A notch 1020 formed into a front face 1022 is sized, shaped and arranged to snugly fit over the front edge 1008 of the circuit board 1002. Being attached to the front edge of the circuit board 1002, the spacer 1012 is thus able to maintain vertical and horizontal spacing of the second leg of each L-shaped pin press-fit into holes formed in the circuit board 1002.

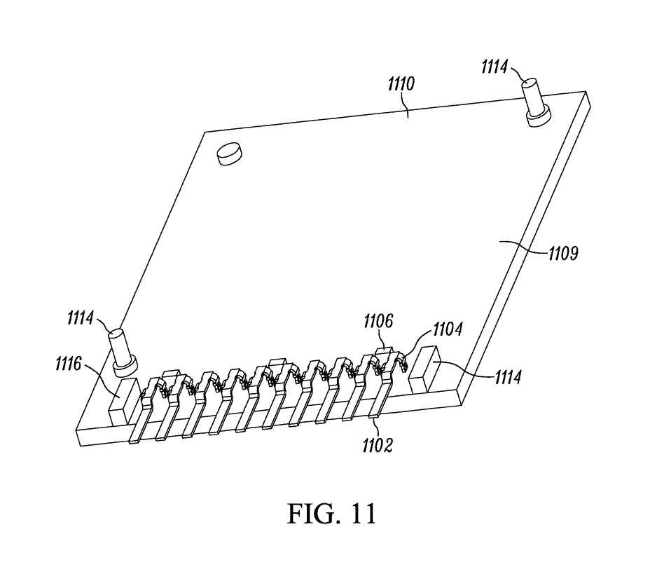

FIGS. 11-14 depict an apparatus and method of assembling an electrical connecting system comprised of a planar circuit board and L-shaped connector pins which are press-fit into holes formed into a circuit board. In FIG. 11, a set of evenly-spaced L-shaped pins 1102 are inserted or attached to mating slots 1104 with their short or first legs 1106 facing or pointing upwardly. The long or second leg of each pin 1102 is horizontal and substantially parallel to the top surface 1104 of an alignment fixture 1110.

The alignment fixture 1110 is provided with registration pins 1114 and stop positioners 1116 which are simply protuberances that extend upwardly from the top surface 1104 of the fixture 1110. The positioners 1116 limit the downward travel of a circuit board over the first legs 1106 of the pins 1102.

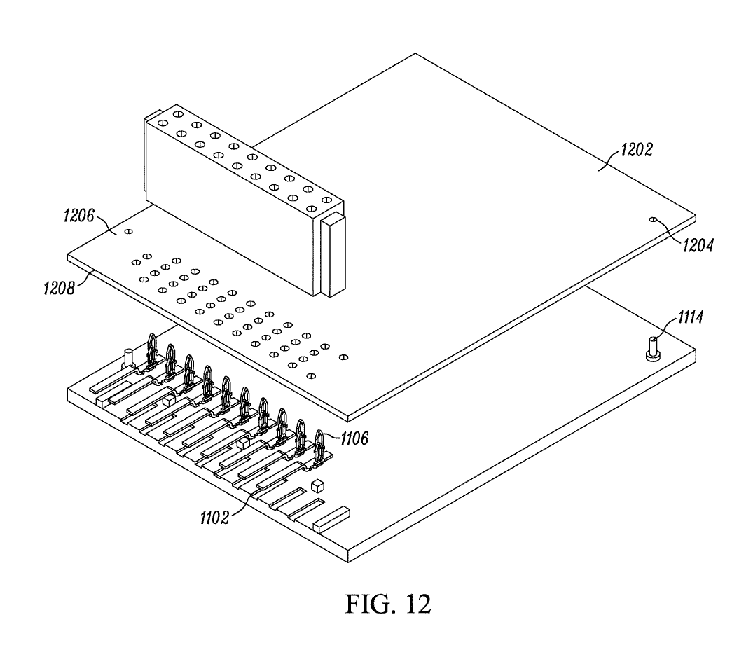

Referring now to FIG. 12, a substantially planar circuit board 1202 having alignment holes 1204 located co-linearly with the reference pins 1114. Several through-holes 1208 formed into the circuit board 1202 align with the first legs 1106 of the pins 1102. A downward force applied to the circuit board 1202 drives the first legs 1106 through the holes 1208 providing an “interference fit” or press-fit between them.

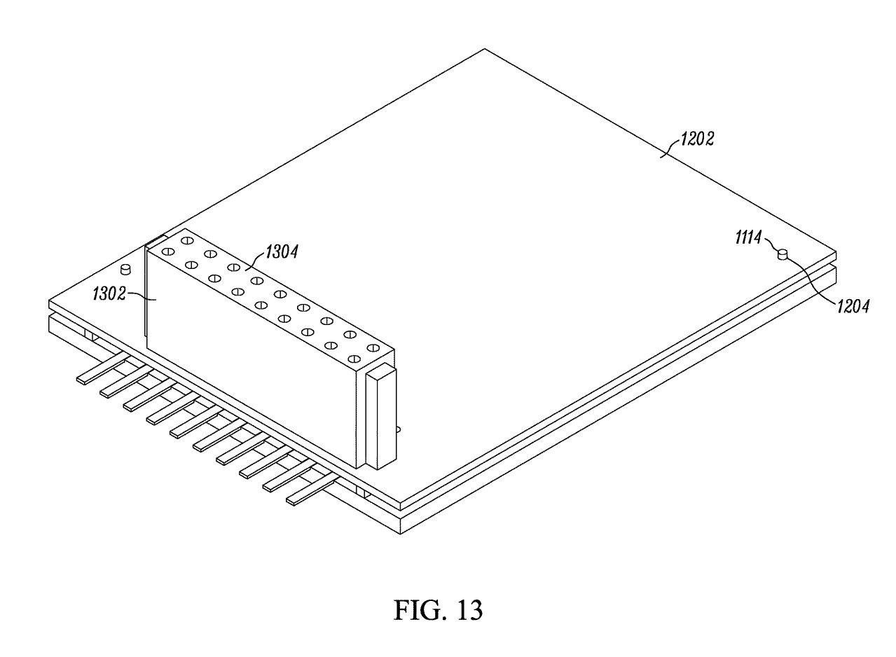

Referring now to FIG. 13, an upper fixture 1302 having several through-holes 1304 is aligned with the first legs 1106, but not visible in FIG. 13. The fixture 1302 maintains the spacing of the first legs as the circuit board 1202 is urged downwardly.

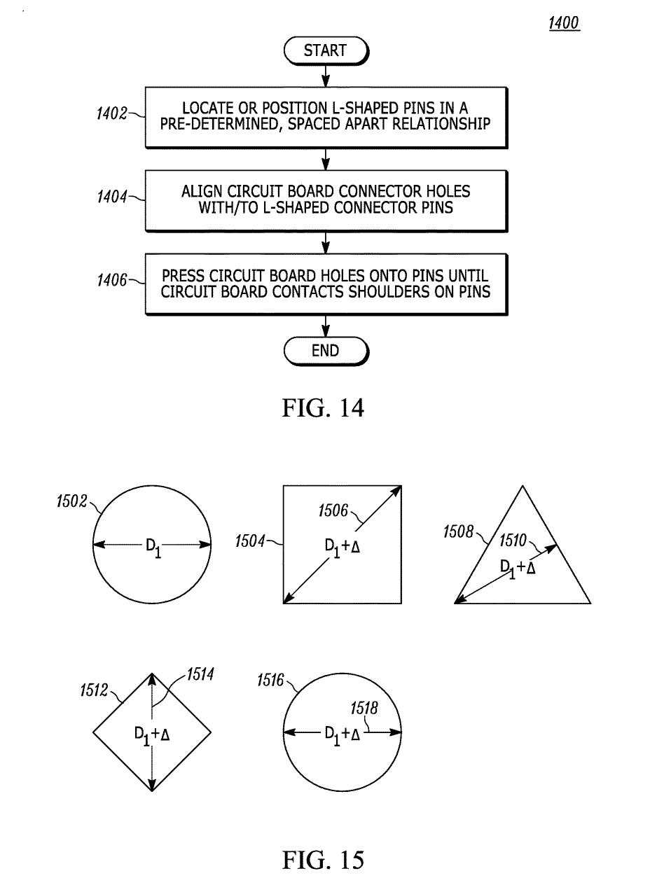

FIG. 14 depicts steps of a method performed by the structure shown in FIGS. 11-13. In a first step 1402, the method 1400 locates or positions the L-shaped pins, as described above for example, in a “pre-determined and spaced-apart relationship.” Such pre-determined spacing can include of course a uniform spacing or non-uniform spacing of the L-shaped pins.

In a second step 1404, a circuit board having connector holes that extend through it, is aligned with the L-shaped connector pins. Those of ordinary skill in the art will of course recognize that an equivalent and alternative step includes aligning the pins to holes in a circuit board.

Once the pins and holes are aligned to each other, regardless of their spacing being uniform or non-uniform, at step 1406 the circuit board is pressed over the pins or alternatively the pins are pressed into the holes to provide an interference fit between them. The method thus terminates at step 1408.

Referring finally to FIG. 15, there is shown a top view of a through-hole 1502, which is substantially circular having a diameter denominated as D₁.

One embodiment of L-shaped pins described above has a cross-sectional shape which is rectangular as identified by reference numeral 1504. Those of ordinary skill in the art know that a rectangle or square has two diagonals which are line segments linking opposite vertices or corners of the rectangle or square. The main diagonal 1506 of the rectangle 1504 has a dimension equal to D₁ plus a small increment Δ in order to have the main diagonal 1506 slightly larger than the diameter of the through-hole 1502.

Another cross-sectional shape for an L-shaped press-fit pin is a triangle. Such a triangle, identified by reference numeral 1508, has a height 1510 which is also D₁ plus a Δ.

A rhombus or diamond 1512 can also provide an interference fit if its main diagonal 1514 has a length equal to D₁ plus a Δ large enough to interfere with the inside diameter of the through-hole. Finally, a circle or annulus 1516 having an outside diameter 1518 D₁+Δ can also provide an interference fit.

Those of ordinary skill in the art should recognize that the connecting systems that use lateral press-fit pins, as described herein, enable the height of an electronic circuit board or module to be reduced, they eliminate the need for pin headers that require high temperature material and they enable connectors having only the number of pins needed for a particular module. The lateral press-fit pins thus provide a reduced cost and higher reliability connector than is possible using prior art connectors.

The foregoing description is for purposes of illustration only. The true scope of the invention is set forth in the following claims.

1. An electrical connecting system comprising:
a substantially planar circuit board having a first side and an opposing second side;
a hole in the circuit board, sized, shaped and arranged to receive a connector pin, the hole having a first cross-sectional shape, a first cross-sectional area and extending through the circuit board;
a substantially L-shaped electrically conductive pin having a first leg with a first length, and an adjacent second leg having a second length, the first leg having a second, cross sectional shape and a second cross sectional area, both the second cross sectional shape and the second cross sectional area of the first leg being substantially constant through-out the entire first length, the first leg being located in and extending through the hole in the circuit board the second leg being connected to the first leg and located above the circuit board, the second leg extending away from the first leg substantially parallel to the first side of the circuit board, the first leg comprising an electrically conductive shoulder extending outwardly from the first leg, the shoulder being configured to rest on top of the first side of the circuit board in electrical and mechanical contact with a conductor on said first side of the circuit board, the shoulder being and sized such that the shoulder will not fit through the hole in the circuit board;
wherein the first cross sectional shape, first cross sectional area, second cross sectional shape and second cross sectional area, are sized, shaped and arranged to provide an interference fit between the hole and the first leg;
wherein the connecting system of claim 1 does not have a housing; and
wherein the connecting system is configured to mount to both sides of a printed circuit board.

2. The connecting system of claim 1, wherein the first leg and second leg have corresponding central axes, the first leg and first central axis being substantially orthogonal to the circuit board when the first leg is in the hole, the first leg having a first terminal end located below the second side of the circuit board and a second terminal end opposite the first terminal end, the second terminal end of the first leg being coincident with a first terminal end of the second leg, the second leg and its first terminal end being located at a first elevation distance above the first side of the circuit board, the first elevation distance being partly determined by the location of the shoulder on the first leg, the second leg of the L-shaped pin being cantilevered from the second end of the first leg and extending away from first leg toward an edge of the circuit board.

3. The connecting system of claim 1, wherein the hole in the circuit board is substantially cylindrical and wherein the first leg has a cross sectional shape, which is non-circular.

4. The connecting system of claim 1, wherein at least a portion of the first leg comprises at least one of: a substantially rhomboid-shaped spring and a substantially hexagon-shaped spring, configured to compress responsive to insertion of the first leg into the hole in the circuit board.

5. (canceled)

6. (canceled)

7. (canceled)

8. (canceled)

9. (canceled)

10. (canceled)

11. (canceled)

12. (canceled)

13. (canceled)

14. (canceled)

15. A method of assembling an electrical connecting system comprising a substantially planar circuit board with holes, which are configured to receive L-shaped connector pins and provide an interference fit with said pins, the L-shaped pins, each having a shoulder, which limits insertion of the L-shaped pins into circuit board holes, the method comprising:
positioning a plurality of L-shaped pins in a fixture, the fixture being configured to hold a plurality of L-shaped pins in a pre-determined spaced-apart relationship relative to each other and with the first legs of the L-shaped pins extending upwardly from said fixture, the first legs of the L-shaped pins also comprising a spring, said shoulder also configured to allow the springs to pass only partway through the holes;
aligning a plurality of holes formed in a circuit board with corresponding upwardly-extending first legs of the L-shaped pins with an alignment pin; and
pressing the circuit board downwardly until the shoulders contact a surface of the circuit board.

16. The method of claim 15, wherein positioning a plurality of L-shaped pins in a fixture, configured to hold a plurality of L-shaped pins in a pre-determined spaced-apart relationship relative to each other comprises positioning a plurality of the L-shaped pins to have a non-uniform pitch.
